(19) United States
(12) Patent Application Publication
(10) Pub. No.: US 2026/0021596 A1
(43) Pub. Date: Jan. 22, 2026

(54) AUTOMATIC LOCKING DEVICE FOR A ROBOT ARM

(71) Applicant: STAUBLI FAVERGES, Faverges-Seythenex (FR)

(72) Inventors: Martin Bay, Filliere (FR); Xavier Diaz, Faverges-Seythenex (FR); Stephane Martin, St Jorioz (FR)

(21) Appl. No.: 19/270,404

(22) Filed: Jul. 15, 2025

(30) Foreign Application Priority Data
Jul. 19, 2024 (FR) 2407978

(51) Int. Cl. B25J 19/00; B25J 9/10; B25J 19/06

(52) U.S. Cl. CPC B25J 19/0004; B25J 19/06; B25J 9/1035

(57) ABSTRACT

The present invention relates to a locking device including: a crown provided with a bore, a hub, mobile in rotation relative to the crown, a plate, integral with the hub, a rocker, mobile in rotation between a locking position and a release position, a groove, opening onto the bore and formed in the rocker or the plate, a guide ramp, formed at a periphery of the rocker or the plate, a pin, mounted in the groove to be blocked between the bore and the guide ramp when the rocker is in the locking position, and a return spring, acting between the plate and the rocker to bring the rocker back to the release position.

### FIELD

The present invention relates to a locking device for a robot arm and a robot arm comprising such a locking device.

### BACKGROUND

Articulated industrial robot arms are subject to gravity, and, depending on their configuration, a sudden stop of the power supply to the axis motors can cause uncontrolled movement of the arm before the motor brake is effectively engaged. This issue particularly affects robot arms that include a vertical linear axis, as gravity applies regardless of the configuration.

KR20120107270A describes a locking device for a vertical axis of a robot arm. The vertical movement of the arm is ensured using a screw rotated by a motor via a belt. The screw is integral with a gear. A lever articulated on the frame has a roller pressing on the belt by the effect of a spring. In case of belt breakage, the spring causes the lever to rotate, and a tooth of the lever blocks the gear.

### SUMMARY

This solution only applies to the breakage of a transmission belt and is ineffective in the event of a sudden power failure of the motor. Moreover, this solution does not allow the screw to be locked by limiting its rotation.

The aim of the invention is to propose a locking device that limits movements due to the weight of the robot arm in case of a power cut to the motor.

To this end, the invention relates to an automatic locking device for a first member and a second member of a robot arm, mobile relative to each other, the locking device comprising:
a crown, provided with a bore, centered on a motor axis fixed relative to the crown and configured to be integral with the first member,
a hub, configured to be rotated around the motor axis relative to the crown, using a motor belonging to the robot arm,
a plate, integral in rotation with the hub around the motor axis,
a rocker, carried by the plate and mobile in rotation relative to the plate around a rocker axis parallel to the motor axis and non-coaxial with the motor axis, between a locking position and a release position,
a groove, formed in a first element among the rocker and the plate, the groove extending radially relative to the motor axis towards the bore following a groove axis,
a guide ramp, formed at a periphery of a second element among the rocker and the plate, the second element being distinct from the first element,
a pin, which is cylindrical and extends along a pin axis, parallel to the motor axis, the pin being mounted in the groove to be mobile in translation along the groove axis relative to the first element when the rocker is in the release position, and to be blocked between the bore and the guide ramp when the rocker is in the locking position, and
a return spring, acting between the plate and the rocker to apply a return force bringing the rocker back to the release position.

In case of a power cut to the motor, the rotation of the plate relative to the crown is blocked thanks to the movement of the pin and the blocking thereof between the bore and the guide ramp. This results in blocking the movement of the second member relative to the first member. The return spring ensures a triggering threshold for the locking device and ensures automatic unlocking of the rotation of the plate relative to the crown when the motor power is restored. Moreover, with the locking device being integrated at the hub level, it can be implemented regardless of the mechanical transmission chosen to drive the second member relative to the first member using the motor.

According to other advantageous aspects of the invention, the locking device comprises one or more of the following features, taken individually or in any technically possible combinations:
When the direction of rotation of the hub is respectively counterclockwise or clockwise around the motor axis relative to the crown, to drive the second member against gravity, the guide ramp is flat and the rocker moves from the release position to the locking position by rotating relative to the plate in the respective clockwise or counterclockwise direction, around the rocker axis, relative to the plate,
the motor axis is arranged between the rocker axis and the groove,
the guide ramp is coplanar with a ramp plane, parallel to the motor axis and inclined relative to a radial plane containing the motor axis and the rocker axis, at an angle of 86 to 90 degrees, preferably 87 to 89 degrees and more preferably 88 degrees,
the pin is free to rotate around the pin axis when the rocker is in the release position, and the rotation of the pin around the pin axis is blocked when the rocker is in the locking position, by the interposition of the pin between the bore and the guide ramp,
when the rocker is in the release position, a center of inertia of the rocker is positioned in a radial plane containing the rocker axis and the motor axis,
when the rocker is in the release position, a center of inertia of an assembly, formed by the plate, the rocker, the return spring, and the pin is positioned on the motor axis,
the first element is the rocker and the second element is the plate,
the first element is the plate and the second element is the rocker,
when the rocker is in the release position, the return force exerted by the return spring tends to bring the pin against a stop wall of the second element,
the guide ramp is a first guide ramp; a second guide ramp, symmetrical to the first guide ramp relative to a radial plane containing the rocker axis and the motor axis, is formed on the second element and, when the rocker is in the release position, the return force exerted by the return spring tends to bring the pin such that the pin axis is in the radial plane,
the locking device comprises an additional rocker, carried by the plate and mobile in rotation relative to the plate around an additional rocker axis parallel to the motor axis and non-coaxial with the motor axis, between a locking position and a release position, an additional groove, formed in a third element among the additional rocker and the plate, the additional groove extending radially relative to the motor axis towards the bore following an additional groove axis, an additional guide ramp, formed at a periphery of a fourth element among the additional rocker and the plate, the fourth element being distinct from the third element, an additional cylindrical pin, which extends along an additional pin axis, parallel to the motor axis, the additional pin being mounted in the additional groove to be mobile in translation along the additional groove axis relative to the third element when the additional rocker is in the release position, to be blocked between the bore and the additional guide ramp when the additional rocker is in the locking position, and an additional return spring, acting between the plate and the additional rocker to apply a return force bringing the additional rocker back to the release position.

The invention also relates to a robot arm comprising a first member, a second member, mobile relative to the first member, and a locking device as described above wherein the first member is driven by the hub and the second member is integral with the crown or the first member is integral with the crown and the second member is driven by the hub.

According to other advantageous aspects of the invention, the robot arm comprises the following features:
the second member is mobile in translation relative to the first member along a vertical axis, the robot arm comprises a pinion integral in rotation with the hub around the motor axis and a rack fixed to the second member, the rack being engaged with the pinion so that the rotation of the pinion around the motor axis causes a translation of the rack relative to the pinion along the vertical axis.

### BRIEF DESCRIPTION OF THE DRAWINGS

The invention will become clearer upon reading the following description, given solely by way of non-limiting example, and made with reference to the drawings wherein:

FIG. 1 is a front view of a robot arm on which a locking device according to a first embodiment of the invention is integrated,

FIG. 2 is a detailed view of FIG. 1 including a local section along a vertical plane passing through a motor axis,

FIG. 3 is a detailed view of the local section of FIG. 2,

FIG. 4 is a front view of the locking device, a rocker being in the release position,

FIG. 5 is a view similar to the view of FIG. 4, the rocker being in a locking position,

FIG. 6 is a view similar to the view of FIG. 3, showing a locking device according to a second embodiment of the invention,

FIG. 7 is a view similar to the view of FIG. 4, showing the locking device of FIG. 6 in a release position,

FIG. 8 is a view similar to the view of FIG. 5, showing the locking device of FIG. 6 in a locking position,

FIG. 9 is a view similar to the view of FIG. 4, showing a locking device according to a third embodiment of the invention,

FIG. 10 is a sectional view along plane X-X of FIG. 9,

FIG. 11 is a sectional view along plane XI-XI of FIG. 9,

FIG. 12 a view similar to the view of FIG. 9, the rocker being in a locking position and an additional rocker being in a release position,

FIG. 13 is a view similar to the view of FIG. 9, the rocker being in a release position and the additional rocker being in a locking position, and

FIG. 14 is a view similar to the view of FIG. 5, showing a locking device according to a fourth embodiment of the invention.

### DETAILED DESCRIPTION

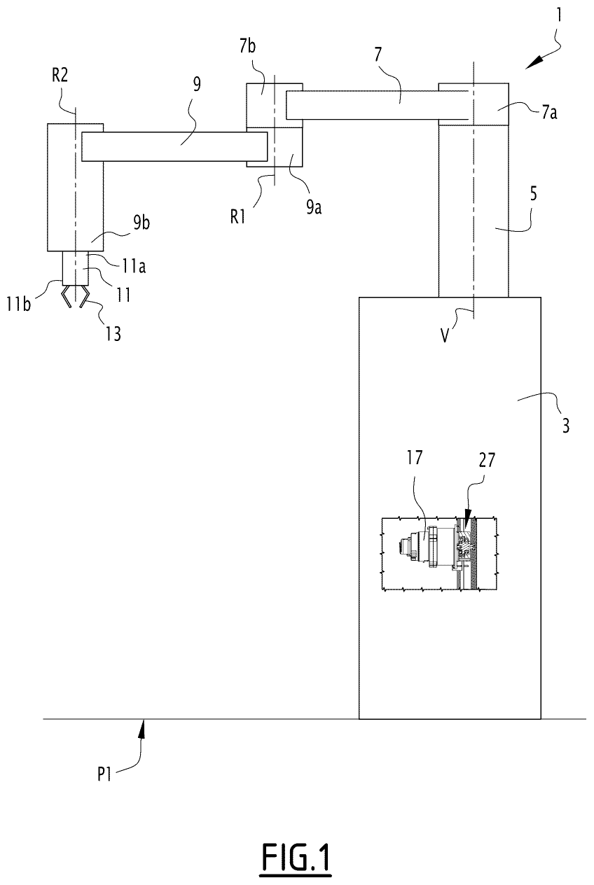

A robot arm 1 according to a first embodiment of the invention is described in FIG. 1. The robot arm 1 comprises a base 3, a column 5, an arm 7, a forearm 9, a flange 11, and a tool 13.

The base 3 is a first member of the robot arm 1 and is fixed relative to a horizontal plane P1 on which the base 3 rests. The horizontal plane P1 can be, for example, a floor, workbench, or table surface.

The column 5 is a second member of the robot arm 1. The column 5, when assembled on the robot arm 1, extends longitudinally along a vertical axis V, perpendicular to the horizontal plane P1. Advantageously, the column 5 is mobile in translation relative to the base 3 along the vertical axis V.

The arm 7, when assembled on the robot arm 1, extends parallel to the horizontal plane P1. The arm 7 is assembled on the column 5, at a first end 7a, and is mobile in rotation relative to the column 5 around the vertical axis V.

The forearm 9, when assembled on the robot arm 1, extends parallel to the horizontal plane P1. The forearm 9 is assembled, at a first end 9a, on a second end 7b of the arm 7 and is mobile in rotation relative to the arm 7 around a first rotation axis R1 parallel to the vertical axis V.

The flange 11, when assembled on the robot arm 1, extends along an axis parallel to the vertical axis V. The flange 11 is assembled, at a first end 11a, on a second end 9b of the forearm 9 and is mobile in rotation relative to the forearm 9 around a second rotation axis R2 parallel to the vertical axis V.

The tool 13 is assembled at a second end 11b of the flange 11. The tool is, for example, a gripper capable of grasping a part.

The robot arm 1 also comprises a movement system 15, to move the column 5 relative to the base 3. The movement system 15 comprises a motor 17 and a mechanical transmission system 19.

The motor 17 extends along a motor axis A17 and comprises a stator 21 fixed to the base 3 and a motor shaft 23 in rotation relative to the stator 21 around the motor axis A17. The motor shaft 23 is thus in rotation around the motor axis A17 relative to the base 3.

Advantageously, the mechanical transmission system 19 comprises a pinion 25 and a rack 26.

The pinion 25 is integral in rotation with the motor shaft 23 around the motor axis A17. The pinion 25 has teeth 36.

The rack 26 is fixed to the column 5 and has teeth, not shown, capable of being engaged by the teeth 36 of the pinion 25 so that the rotation of the pinion 25 around the motor axis A17 causes, via the rack 26, the vertical translation of the column 5 relative to the base 3.

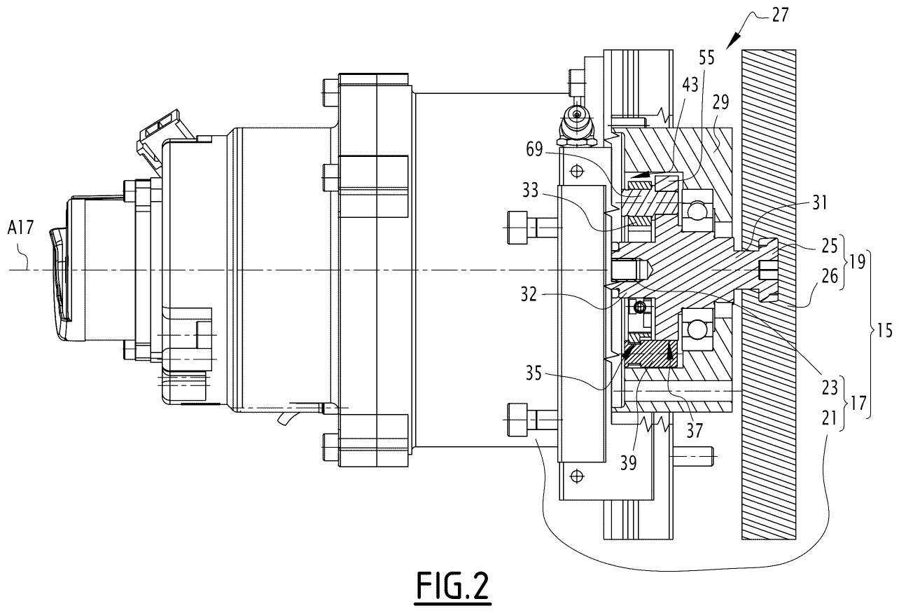

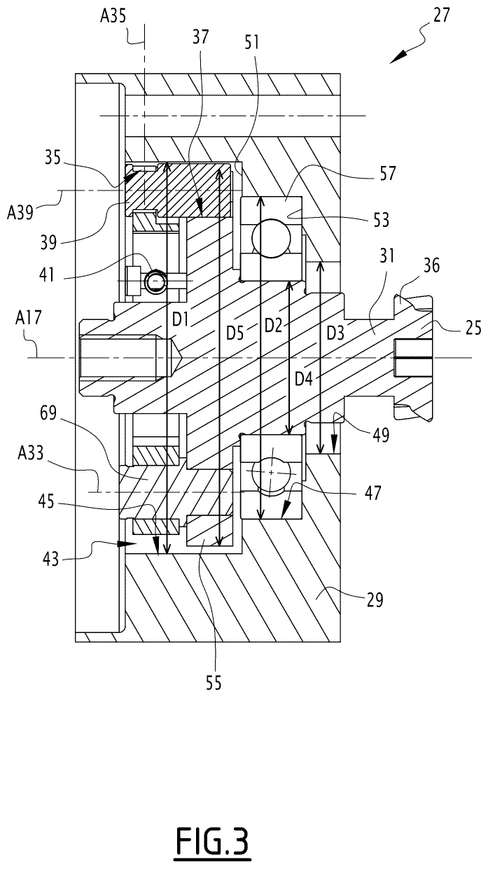

The robot arm 1 also comprises an automatic locking device 27 of the robot arm 1 described in FIGS. 2 to 5.

The locking device 27 comprises a crown 29, a hub 31, a rocker 33, a groove 35, a guide ramp 37, a pin 39, and a return spring 41.

The crown 29 is provided with a bore 43 centered on the crown 29 and passing through the crown 29 from side to side along the motor axis A17 when the crown 29 is mounted on the robot arm 1.

The bore 43 has a first internal portion 45, with a first internal diameter D1, a second internal portion 47, with a second internal diameter D2, smaller than the first internal diameter D1, and a third internal portion 49, with a third internal diameter D3, smaller than the second internal diameter D2. The reduction in diameter between the first internal diameter D1 and the second internal diameter D2 forms a first shoulder 51 belonging to the bore 43, and the reduction in diameter between the second internal diameter D2 and the third internal diameter D3 forms a second shoulder 53 belonging to the bore 43.

When the crown 29 is mounted on the robot arm 1, the crown 29 is centered on the motor axis A17 and is fixed on the stator 21, the first internal portion 45 being turned towards the stator 21. Thus, the crown 29 is integral with the base 3.

The hub 31 is cylindrical and has an external diameter D4 smaller than the third internal diameter D3.

The hub 31 comprises a plate 55. The plate 55 extends perpendicularly to a revolution axis of the hub 31, which when the hub 31 is mounted on the robot arm 1 is coaxial with the motor axis A17. The plate 55 is a piece of revolution around the motor axis A17 when the hub 31 is mounted on the robot arm 1 and defines a second external diameter D5 larger than the first external diameter D4 and smaller than the first internal diameter D1.

Advantageously, the pinion 25 is integral with the hub 31. More precisely, the pinion 25 and the hub 31 are formed by a single monobloc piece. Alternatively, the pinion 25 can be a separate piece fixed by screws.

An end 32 of the hub 31 is mounted on the motor shaft 23 and is integral in rotation with the motor shaft 23 around the motor axis A17. When the hub 31 is mounted on the motor shaft 23, the hub 31 is partially contained in the bore 43. More precisely, the plate 55 is contained in the first internal portion 45 of the bore 43, and the pinion 25 protrudes outside the bore 43.

The locking system 27 comprises a ball bearing 57, interposed between the second internal portion 47 and the hub 31 and abutting against the second shoulder 53. Thus, the hub 31 is configured to be rotated around the motor axis A17 relative to the crown 29.

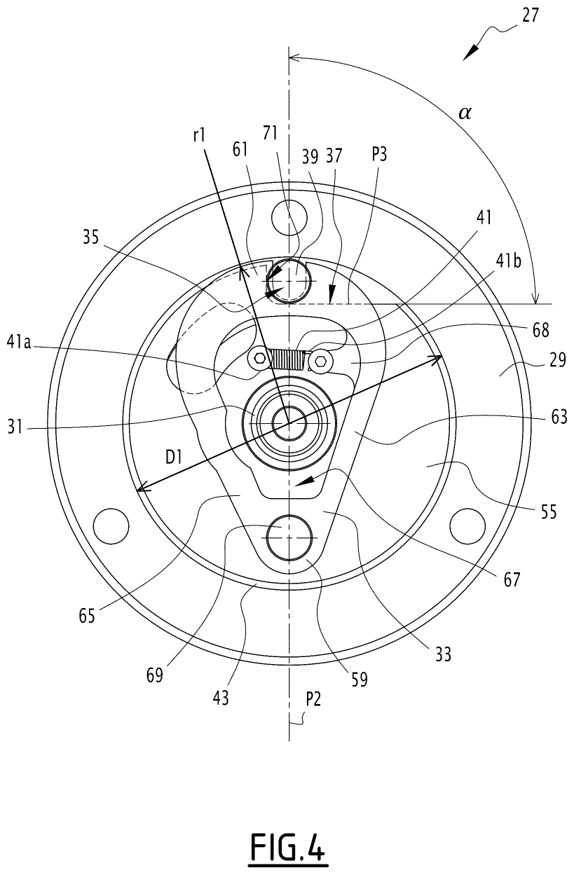

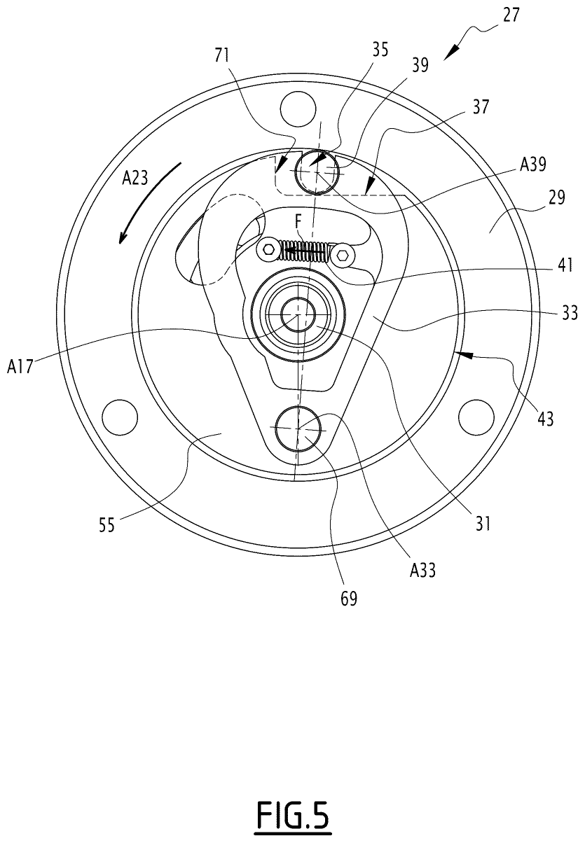

The rocker 33 has an ovoid shape, in projection in a plane perpendicular to the motor axis A17, as visible in FIGS. 4 and 5. The rocker 33 comprises a rounded base 59, a rounded portion 61, a first leg 63, and a second leg 65. The first leg 63 and the second leg 65 connect the rounded base 59 to the rounded portion 61, defining a recess 67 between the rounded portion 61, the rounded base 59, the first leg 63, and the second leg 65.

The rounded portion 61 has a radius r1 smaller than the first diameter D1 divided by two.

The first leg 63 comprises, at the junction with the rounded portion 61, a protrusion 68 that extends into the recess 67.

The rocker 33 is carried by the hub 31 and is integral in rotation with the hub 31 around the motor axis A17. More precisely, the rocker is mounted on the plate 55 via a rocker shaft 69 that extends along a rocker axis A33 parallel to the motor axis A17 and non-coaxial with the motor axis A17. The rocker shaft 69 is fixed to the plate 55, and the rounded base 59 is mounted mobile in rotation on the rocker shaft 69. The rocker is thus mobile in rotation, relative to the hub 31, around the rocker axis A33 between a release position and a locking position.

The rocker 33 is positioned along the motor axis A17 between the stator 21 and the plate 55, and the end 32 of the hub 31 passes through the recess 67.

Advantageously, when the rocker 33 is in the release position, a center of inertia of the rocker 33 is positioned in a radial plane P2 containing the rocker axis A33 and the motor axis A17. Thus, the rocker 33 is insensitive to a centrifugal force acting on the rocker 33 when it is in rotation around the motor axis A17. The center of inertia of the rocker is located on the side of the motor axis A17 relative to the rocker axis A33.

The return spring 41 is fixed at a first end 41a to the plate 55 and at a second end 41b to the protrusion 68. The return spring 41 acts on the plate 55 and on the rocker 33 to apply a return force F that tends to bring the rocker 33 from the locking position to the release position.

The groove 35 is formed in a first element among the rocker 33 and the plate 55. In this example, the groove 35 is, advantageously, formed on the rocker 33, the rocker 33 thus constituting the first element. The groove 35 extends radially relative to the motor axis A17 towards the bore 43 following a groove axis A35. The groove 35 opens radially into the bore 43. In this example, the groove 35 passes through the plate 55 parallel to the motor axis A17.

Advantageously, the motor axis A17 is arranged between the rocker axis A33 and the groove 35. This design allows for a compact locking system 27.

The guide ramp 37 is flat and formed at a periphery of a second element among the rocker 33 and the plate 55, the second element being distinct from the first element. In this example, the guide ramp 37 is, advantageously, formed at the periphery of the plate 55. The plate 55 thus constitutes the second element. The guide ramp 37 passes through the radial plane P2 and extends perpendicularly to the rocker axis A33 up to the bore 43.

The guide ramp 37 is perpendicular to a radius of the plate 55. More precisely, the guide ramp 37 is coplanar with a ramp plane P3. The ramp plane P3 is parallel to the motor axis A17 and, advantageously, inclined relative to the radial plane P2 at an angle α between 86 and 90 degrees, preferably 87 to 90 degrees, and more preferably 88 degrees.

The plate advantageously comprises a stop wall 71 that extends the guide ramp 37. The stop wall 71 is parallel to the radial plane P2.

The pin 39 is cylindrical and extends along a pin axis A39, which, when the pin is mounted on the robot arm 1, is parallel to the motor axis A17. The pin is mounted in the groove 35 to be mobile in translation along the groove axis A35 relative to the rocker 33 when the rocker 33 is in the release position and to be blocked between the bore 43 and the guide ramp 37 when the rocker 33 is in the locking position. The groove axis A35 is perpendicular to the rocker axis A33 and is comprised in the radial plane P2 when the rocker 33 is in the release position. The groove 35 guides the pin 39 between the release position and the locking position of the rocker 33.

When the robot arm 1 is in a normal operating phase, that is, when the motor shaft 23 is in rotation around the motor axis A17 in the clockwise direction relative to the crown 29, the rocker 33 is in the release position, and the pin 39 is free to move along the groove 35 between the guide ramp 37 and the bore 43. The hub 31, the rocker 33, and the pin 39 are then in rotation relative to the crown 29 around the motor axis A17.

Advantageously, the pin 39 is also free to rotate around the pin axis A39 when the rocker 33 is in the release position so as not to hinder the rotation of the hub 31 and the rocker 33 when the robot arm 1 is in a normal operating phase and the pin 39 is in contact with the bore 43.

Advantageously, when the locking device 27 is not activated, that is, when the rocker 33 is in the release position, the return force F tends to bring the pin 39 against the stop wall 71.

When the locking device 27 is not activated, the pin axis A39, the motor axis A17, and the rocker axis A33 are in the radial plane P2, and, advantageously, a center of inertia of an assembly, formed by the hub 31, the rocker 33, the return spring 41, and the pin 39 is positioned on the motor axis A17. This design of the locking device 27 ensures dynamic balance in the normal operating phases of the robot arm 1, in other words, it guarantees that the centrifugal force acting on the rocker 33 does not trigger the locking of the locking device 27.

During a power cut to the motor 17, the action of gravity causes the column 5 to fall, and the motor shaft 23 undergoes a strong acceleration A23 in the counterclockwise direction, as shown in FIG. 5, due to its inertia, the rocker 33 then rotates from the release position to the locking position relative to the plate 55 around the rocker axis A33, advantageously, in the clockwise direction so that the pin 39 moves, along the groove axis A35, along the groove 35 and along the guide ramp 37 until it comes into contact with the bore 43 of the crown 29. When the rocker 33 is in the locking position, the plate 55 and the bore 43 pinch the pin 39, interposed between the bore 43 and the guide ramp 37, and the rotation of the pin 39 around the pin axis A39 is, advantageously, blocked. Thus, the pin 39 directly blocks the plate 55 relative to the crown 29, and the motor shaft 23 can no longer rotate. The fall of the column 5 of the robot arm 1 is then stopped.

When the rocker 33 moves from the release position to the locking position, the pin 39 rolls on the guide ramp 37 so that the friction forces, exerted on the pin 39, which add to the return force F of the return spring 41, unfavorable to the movement of the rocker 33 from the release position to the locking position, are limited and more stable.

The inclination of the guide ramp 37 prevents the pin 39 from bouncing on the bore 43 from the locking position to the release position when the locking device 27 is activated. The inclination of the guide ramp 37 also ensures a permanent wedging of the pin 39 between the bore 43 and the plate 55.

The return force F of the return spring 41 is chosen based on the value of the angular acceleration at which the triggering of the locking device 27 is desired. Thus, there is an acceleration threshold for the rocker 33 to start moving to the locking position. This allows the motor shaft 23 to rotate up to a defined acceleration threshold in the counterclockwise direction and ensures that the plate 55 and the rocker 33 will never be blocked in the clockwise direction.

To unlock the locking device 27, simply activate the motor 17 in the clockwise direction.

In an unrepresented variant, the mechanical transmission system 19 comprises the pinion 25 integral in rotation with the motor shaft 23 and a belt fixed to the column 5 and driven by the pinion 25 so that the rotation of the pinion 25 around the motor axis A17 causes the vertical translation of the column 5 relative to the base 3 via the belt.

In an unrepresented variant, the mechanical transmission system 19 comprises the pinion 25 integral in rotation with the motor shaft 23 and a worm screw fixed to the column 5 and engaged by the pinion 25 so that the rotation of the pinion 25 around the motor axis A17 causes the vertical translation of the column 5 relative to the base 3 via the worm screw.

More generally, the invention is applicable to a motor that would drive the column 5 in translation relative to the base 3.

In an unrepresented variant, in normal operation, the motor shaft 23 is in rotation relative to the crown 29 in the counterclockwise direction. When the motor shaft 23 undergoes a strong acceleration in the clockwise direction, the rocker 33 moves from the release position to the locking position by rotating relative to the rocker axis A33 in the clockwise direction.

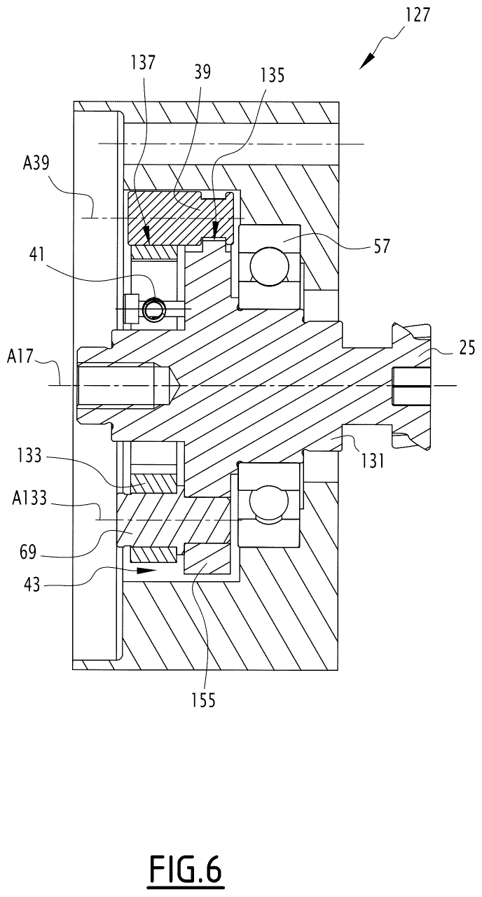

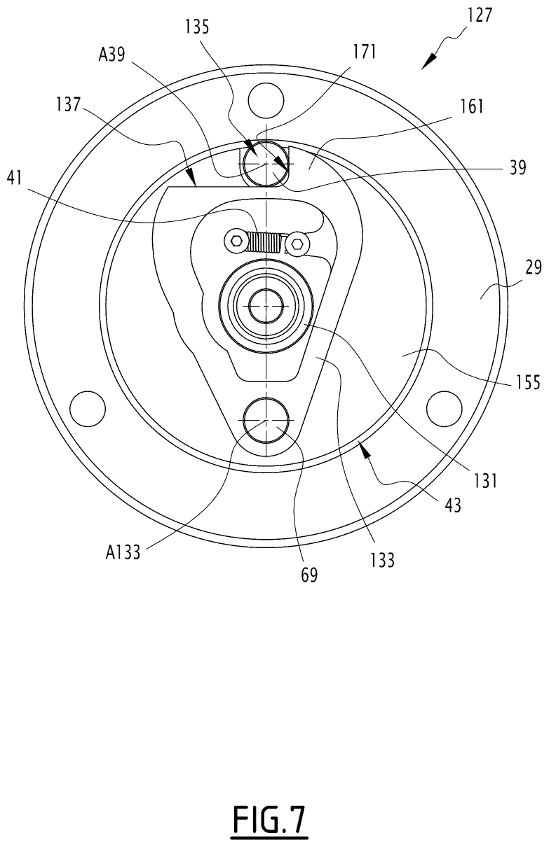

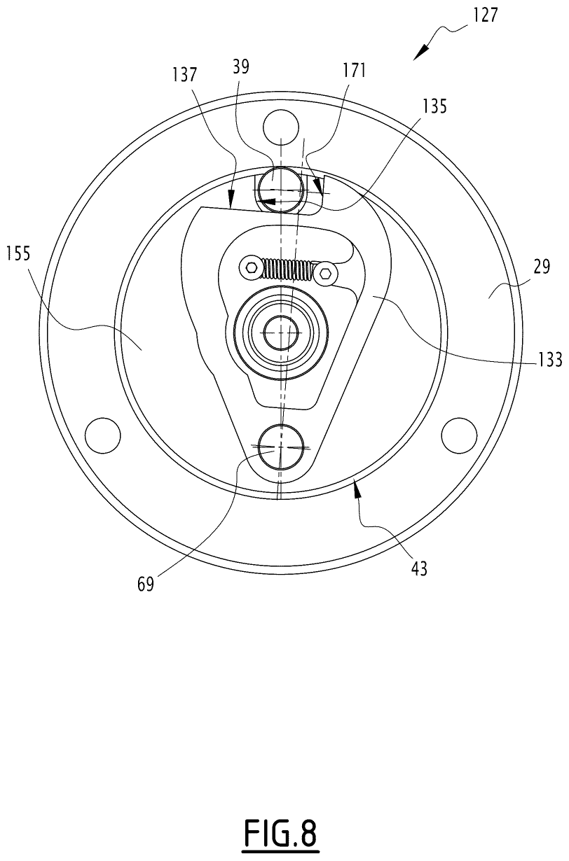

A locking device 127, according to a second embodiment, is shown in FIGS. 6 to 8. The reference signs of the locking device 127 correspond to those of the locking device 27 when the referenced element is the same. The reference signs are increased by 100 compared to those of the locking device 27 when they designate elements modified in the locking device 127 compared to the locking device 27.

If an element is referenced in one of FIGS. 6 to 8 without being mentioned in the description, it corresponds to the element bearing the same reference in the first embodiment.

The locking device 127 is identical to the locking device 27 of the first embodiment, except for the characteristics described below.

The groove 135 is formed in the plate 155, and the guide ramp 137 and the stop wall 171 are formed at a periphery of the rounded portion 161 of the rocker 133. The groove 135 extends radially relative to the motor axis A17 towards the bore 43 following a groove axis that is in the plane P2. The operation of the locking device 127 is similar to the locking device 27 when the rocker 133 moves from the release position to the locking position, the pin 39 is wedged between the bore 43 and the guide ramp 137.

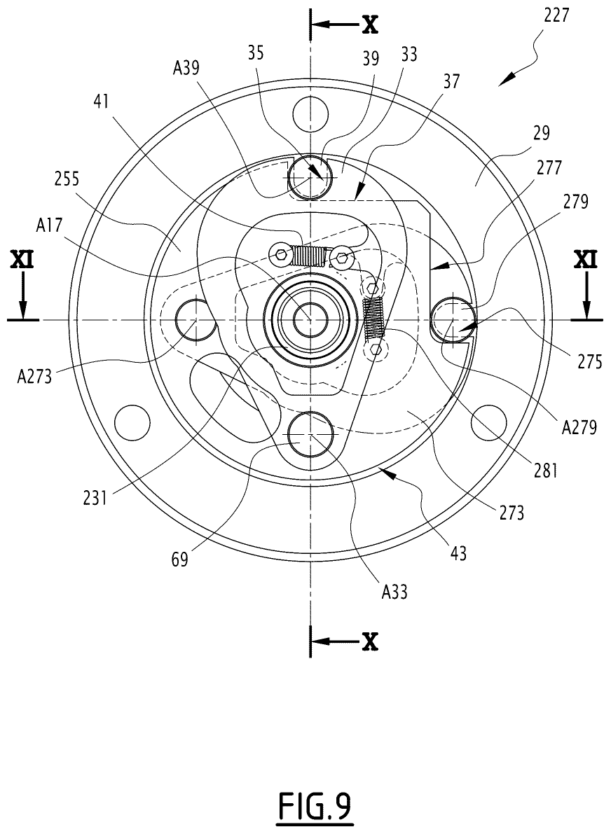

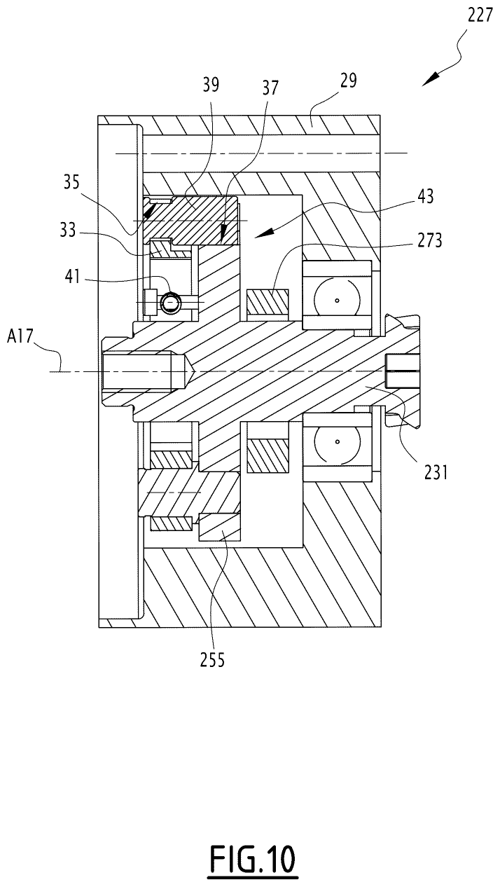

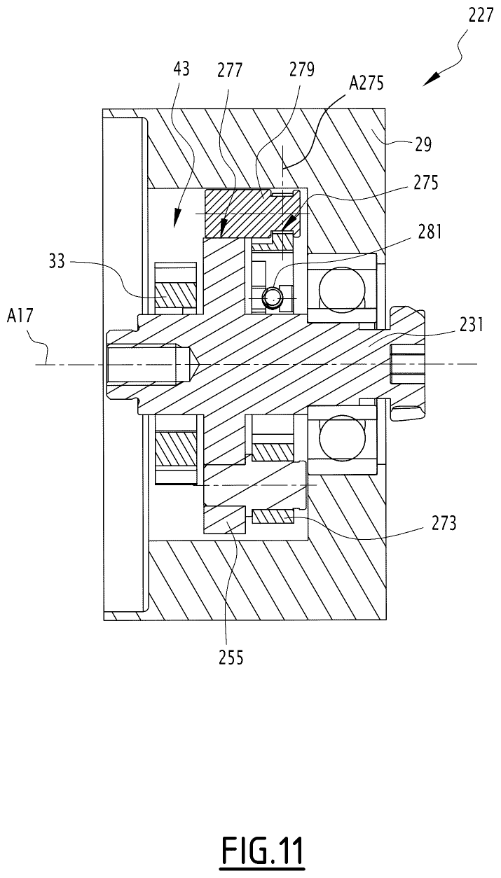

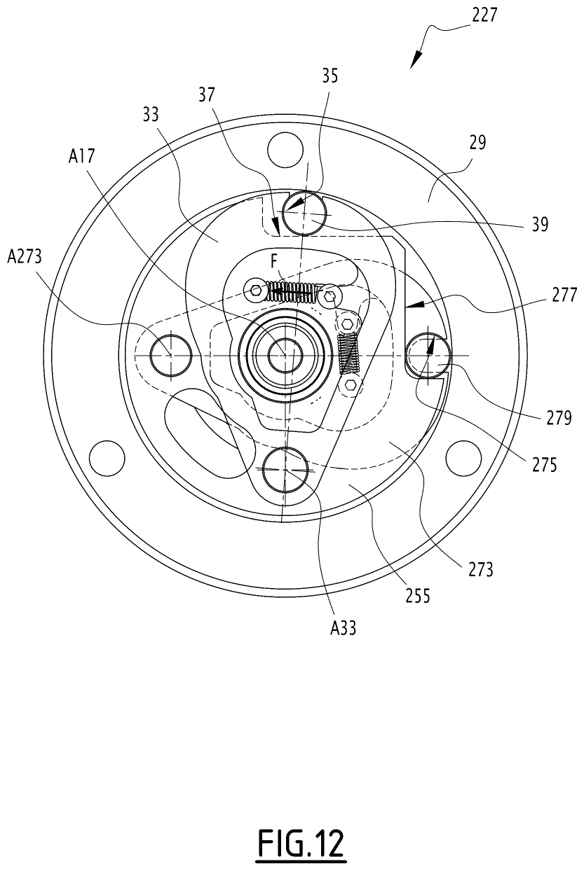

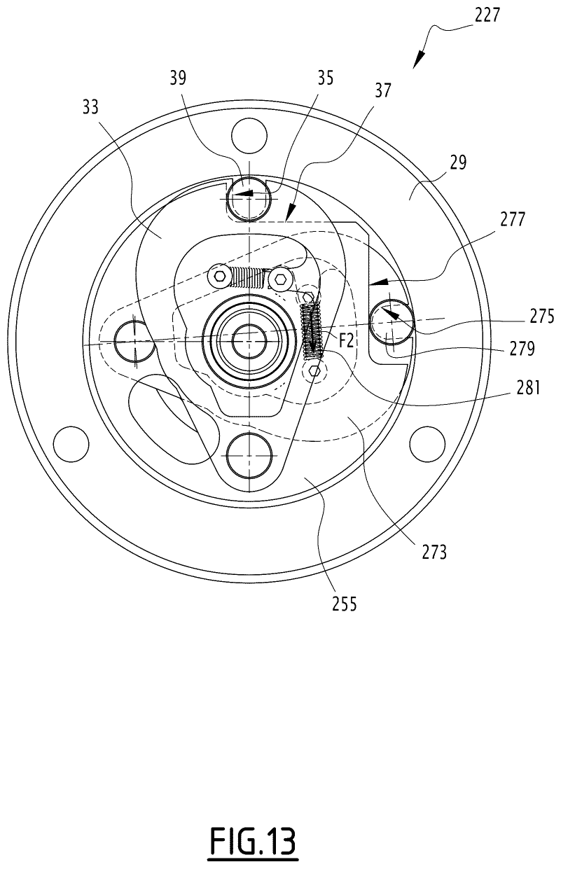

A locking device 227, according to a third embodiment, is shown in FIGS. 9 to 13. The reference signs of the locking device 227 correspond to those of the locking device 27 when the referenced element is the same. The reference signs are increased by 200 compared to those of the locking device 27 when they designate elements modified in the locking device 227 compared to the locking device 27.

If an element is referenced in one of FIGS. 9 to 13 without being mentioned in the description, it corresponds to the element bearing the same reference in the first embodiment.

The locking device 227 is identical to the locking device 27 of the first embodiment, except for the characteristics described below.

The locking device 227 comprises an additional rocker 273, similar to the rocker 33, carried by the plate 255 and mobile in rotation relative to the plate 255 around an additional rocker axis A273 parallel to the motor axis A17 and non-coaxial with the motor axis A17, between a locking position and a release position. The angle formed by the rocker axis A33, the motor axis A17, and the additional rocker axis A273 is equal to 90 degrees. The additional rocker 273 moves from the release position to the locking position in the opposite direction to the rocker 33 so that the additional rocker 273 is in the release position, in the respective locking position, when the rocker 33 is in the locking position, in the respective release position. Alternatively, the angle formed by the rocker axis A33, the motor axis A17, and the additional rocker axis A273 could be different from 90 degrees and be, for example, equal to 180 degrees.

The locking device 227 comprises an additional groove 275 formed in a third element among the additional rocker 273 and the plate 255. In this example, the additional groove 275 is formed on the additional rocker 273. The additional groove 275 extends radially relative to the motor axis A17 towards the bore 43 following an additional groove axis A275 and opens into the bore 43.

The locking device 227 comprises an additional guide ramp 277, formed at a periphery of a fourth element among the additional rocker 273 and the plate 255, the fourth element being distinct from the third element. In this example, the additional guide ramp 277 is formed at the periphery of the plate 255.

The locking device 227 comprises an additional cylindrical pin 279, which extends along an additional pin axis A279, parallel to the motor axis A17, the additional pin 279 being mounted in the additional groove 275 to be mobile in translation along the additional groove axis A275 relative to the additional rocker 273 when the additional rocker 273 is in the release position, and to be blocked between the bore 43 and the additional guide ramp 277 when the additional rocker 273 is in the locking position.

The locking device 227 comprises an additional return spring 281, acting between the plate 255 and the additional rocker 273 to apply a return force F2 bringing the additional rocker 273 back to the release position.

The guide ramp 37 and the additional guide ramp 277 are opposed so that when the motor shaft undergoes a strong acceleration in one direction of rotation around the motor axis A17, the additional rocker 273 moves to the locking position, and the additional pin 279 blocks the rotation between the plate 255 and the crown 29, and when the motor shaft undergoes a strong acceleration in another direction of rotation around the motor axis A17, the rocker 33 moves to the locking position, and the pin 39 blocks the rotation between the plate 255 and the crown 29. Thus, the locking system 227 blocks the rotation of the plate 255 relative to the crown 29 as soon as the motor shaft 23 is subjected to a strong acceleration, regardless of the direction of rotation. The locking device 227 thus allows the blocking of the second member 5 relative to the first member 3 in both directions of rotation of the hub 31 when the angular accelerations of the hub 31 exceed a threshold that is adjustable by the choice of the return spring 41 and the additional return spring 281.

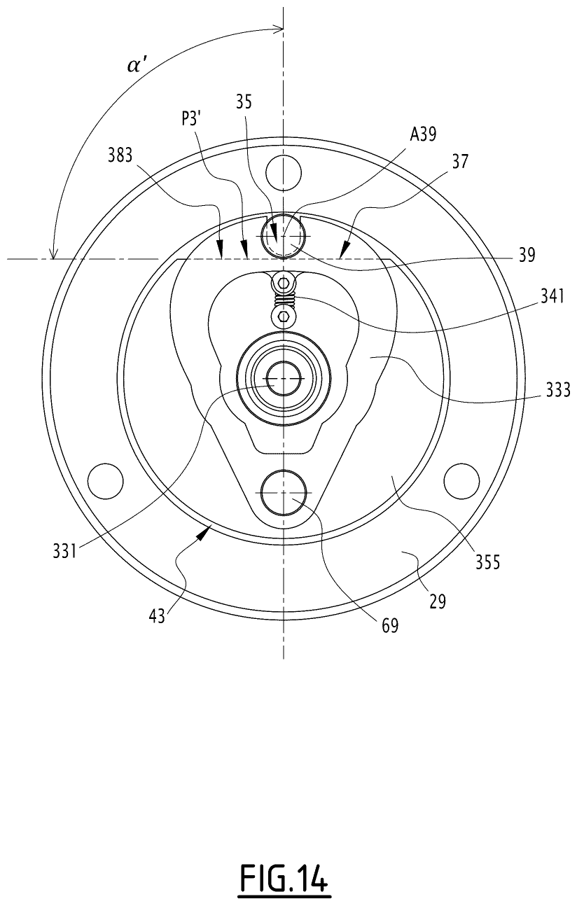

A locking device 327, according to a fourth embodiment, is shown in FIG. 14. The reference signs of the locking device 327 correspond to those of the locking device 27 when the referenced element is the same. The reference signs are increased by 300 compared to those of the locking device 27 when they designate elements modified in the locking device 327 compared to the locking device 27.

If an element is referenced in FIG. 14 without being mentioned in the description, it corresponds to the element bearing the same reference in the first embodiment.

The locking device 327 is identical to the locking device 27 of the first embodiment, except for the characteristics described below.

The plate 355 comprises a second guide ramp 383 symmetrical to the first guide ramp 37 relative to a radial plane P2.

The second guide ramp 327 is perpendicular to a radius of the plate 355. More precisely, the guide ramp 383 is coplanar with a ramp plane P3′. The ramp plane P3′ is parallel to the motor axis A17 and, advantageously, inclined relative to the radial plane P2 at an angle α′ between 86 and 90 degrees, preferably 87 to 90 degrees, and more preferably 88 degrees.

When the rocker 333 is in the release position, the return force F exerted by the return spring 341 tends to bring the pin 39 such that the pin axis A39 is in the radial plane P2. The pin 39 then occupies a position of equilibrium between the guide ramp 37 and the second guide ramp 383.

It is understood that the locking device 327 does not comprise a stop wall extending the first ramp 35. Thus, the rocker 333 can tilt in any direction of rotation when the motor shaft 23 is subjected to a strong acceleration, regardless of the direction of rotation of the motor shaft 23, so as to wedge the pin 39 between the plate 355 and the bore 43 to block the rotation of the motor shaft 23.

The return spring 341 acts between the rocker 333 and the plate 355 so as to be able to return the rocker 333 to the release position regardless of the direction of rotation of the rocker 333 relative to the plate 355.

In the described embodiments of the invention, the stator 21 is integral with the base 3, while the rack 26 is integral with the column 5, the invention is fully applicable to a robot arm wherein the stator is integral with the column, and the rack is fixed relative to the base.

Similarly, in the described embodiments of the invention, the motor shaft is the rotor of the electric motor, the invention is fully applicable if the motor shaft is the output shaft of a reducer coupled to an electric motor.

Moreover, the invention is applicable to a robot arm wherein the first member is mobile in rotation relative to the second member. For example, it could be implemented on the articulation of the forearm on the arm of a 6-axis industrial robot.

Any feature described above for one embodiment or variant is applicable to the other described embodiments and variants, as long as it is technically possible.

What is claimed is:

1. An automatic locking device of a first member and a second member of a robot arm, mobile relative to each other, the locking device comprising:
a crown, provided with a bore, centered on a motor axis fixed relative to the crown and configured to be integral with the first member,
a hub, configured to be rotated around the motor axis relative to the crown, using a motor belonging to the robot arm,
a plate, integral in rotation with the hub around the motor axis,
a rocker carried by the plate and mobile in rotation relative to the plate around a rocker axis parallel to the motor axis and non-coaxial with the motor axis, between a locking position and a release position,
a groove, formed in a first element among the rocker and the plate, the groove extending radially relative to the motor axis towards the bore following a groove axis,
a guide ramp, formed at a periphery of a second element among the rocker and the plate, the second element being distinct from the first element,
a pin, which is cylindrical and extends along a pin axis, parallel to the motor axis, the pin being mounted in the groove to be mobile in translation along the groove axis relative to the first element when the rocker is in the release position, and to be blocked between the bore and the guide ramp when the rocker is in the locking position, and
a return spring, acting between the plate and the rocker to apply a return force bringing the rocker back to the release position.

2. The locking device according to claim 1, wherein, when a direction of rotation of the hub is counterclockwise, respectively clockwise, around the motor axis relative to the crown, to drive the second member against gravity, the guide ramp is flat, and the rocker moves from the release position to the locking position by rotating relative to the plate in the clockwise direction, respectively counterclockwise direction, around the rocker axis, relative to the plate.

3. The locking device according to claim 1, wherein the motor axis is arranged between the rocker axis and the groove.

4. The locking device according to claim 1, wherein the guide ramp is coplanar with a ramp plane, parallel to the motor axis and inclined relative to a radial plane containing the motor axis and the rocker axis, at an angle of 86 to 90 degrees.

5. The locking device according to claim 4, wherein the angle is equal to 87 to 89 degrees.

6. The locking device according to claim 5, wherein the angle is equal to 88 degrees.

7. The locking device according to claim 1, wherein:
the pin is free to rotate around the pin axis when the rocker is in the release position, and
the rotation of the pin around the pin axis is blocked when the rocker is in the locking position, by an interposition of the pin between the bore and the guide ramp.

8. The locking device according to claim 1, wherein, when the rocker is in the release position, a center of inertia of the rocker is positioned in a radial plane containing the rocker axis and the motor axis.

9. The locking device according to claim 1, wherein, when the rocker is in the release position, a center of inertia of an assembly, formed by the plate, the rocker, the return spring, and the pin is positioned on the motor axis.

10. The locking device according to claim 1, wherein the first element is the rocker and the second element is the plate.

11. The locking device according to claim 1, wherein the first element is the plate and the second element is the rocker.

12. The locking device according to claim 1, wherein, when the rocker is in the release position, the return force exerted by the return spring tends to bring the pin against a stop wall of the second element.

13. The locking device according to claim 1, wherein:
the guide ramp is a first guide ramp,
a second guide ramp, symmetrical to the first guide ramp relative to a radial plane containing the rocker axis and the motor axis, is formed on the second element, and
when the rocker is in the release position, the return force exerted by the return spring tends to bring the pin such that the pin axis is in the radial plane.

14. The locking device according to claim 1, comprising:
an additional rocker, carried by the plate and mobile in rotation relative to the plate around an additional rocker axis parallel to the motor axis and non-coaxial with the motor axis, between a locking position and a release position,
an additional groove, formed in a third element among the additional rocker and the plate, the additional groove extending radially relative to the motor axis towards the bore following an additional groove axis,
an additional guide ramp, formed at a periphery of a fourth element among the additional rocker and the plate, the fourth element being distinct from the third element,
an additional cylindrical pin, which extends along an additional pin axis, parallel to the motor axis, the additional pin being mounted in the additional groove to be mobile in translation along the additional groove axis relative to the third element when the additional rocker is in the release position, and to be blocked between the bore and the additional guide ramp when the additional rocker is in the locking position, and
an additional return spring, acting between the plate and the additional rocker to apply a return force bringing the additional rocker back to the release position.

15. A robot arm, comprising:
a first member,
a second member, mobile relative to the first member, and
a locking device according to claim 1 wherein the first member is driven by the hub and the second member is integral with the crown or the first member is integral with the crown and the second member is driven by the hub.

16. The robot arm according to claim 15, wherein the second member is mobile in translation relative to the first member along a vertical axis.

17. The robot arm according to claim 16, comprising a pinion integral in rotation with the hub around the motor axis and a rack fixed to the second member, the rack being engaged with the pinion so that the rotation of the pinion around the motor axis causes a translation of the rack relative to the pinion along a vertical axis.
